(19) United States
(12) Patent Application Publication
(10) Pub. No.: US 2016/0044087 A1
(43) Pub. Date: Feb. 11, 2016

(54) USER CONTACT INFORMATION PRIVACY PROTECTION IN COMPUTER NETWORKS

(71) Applicants: Piragash Velummylum, Seattle, WA (US); Jordan Michael Timmermann, Seattle, WA (US); Jared Allen Russell, Redmond, WA (US); Leelynne Jacob Faris, Seattle, WA (US); Neil Alan Pankey, Seattle, WA (US)

(72) Inventors: Piragash Velummylum, Seattle, WA (US); Jordan Michael Timmermann, Seattle, WA (US); Jared Allen Russell, Redmond, WA (US); Leelynne Jacob Faris, Seattle, WA (US); Neil Alan Pankey, Seattle, WA (US)

(21) Appl. No.: 14/452,399

(22) Filed: Aug. 5, 2014

(51) Int. Cl. H04L 29/08; G06F 17/30; H04L 12/58; H04L 29/06

(52) U.S. Cl. CPC H04L 67/08; H04L 65/403; G06F 17/30486; H04L 51/04

(57) ABSTRACT

A method and a device are disclosed including software components that are executed on a computing device to enable finding, adding, and sending messages to users within a social network. In various embodiments, a requesting user may request finding, adding, and/or sending messages to one or more other users in a social network, the other users presently being on one or more contact lists associated with the requesting user. The requesting user's contact list may be used to verify that he knows the other users and respond to the requesting user's request based on the requesting user's own contact list, without supplying additional information from the other users. In various embodiments, the requesting user's contact list may be partitioned into two sections, one section including the other users who are also in the social network and the other including the other users who are not in the social network.

### TECHNICAL FIELD

This application relates generally to social networking. More specifically, this application relates to computer implemented search and processing of user contact information while preserving user privacy.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example user online interaction environment including social networks and other communication networks, each network with its own set of contact lists;

FIG. 4A shows an example social network with a user and friends, each being a member of the same social network as the user;

FIG. 4B shows an example social network with a user and friends, each being a member of a different network than the user;

FIG. 5A shows an example social network partitioning a user's contact list into two sections based on membership in the social network;

FIG. 5B shows an example contact list details of a user of a social network; and

FIG. 6 shows an example process of encryption and protection of a user's contacts.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular user networks such as social networks, it will be appreciated that the disclosure may be used with other types of user networks such as large corporations, enterprises, government networks, networks in various clubs and societies, and the like.

Briefly described, a system and a method are disclosed including software components that are executed on a computing device to enable finding, adding, and sending messages to users within a social network. In various embodiments, a requesting user may request finding, adding, and/or sending messages to one or more other users in a social network, the other users presently being on one or more contact lists associated with the requesting user. One or more of the contact lists associated with the requesting user may be used to verify that the requesting user knows the other users and respond to the requesting user's request based on the requesting user's own contact list, without supplying additional information from the other users to the requesting user. In various embodiments, the requesting user's contact list may be partitioned into two sections, one section including the other users who are also in the social network and the other section including the other users who are not in the social network. The acts of finding friends, adding friends, and communicating with friends may be done in such a way as to provide maximum information to the initiators of these actions without exposing any additional private information about the recipients of these actions.

With the ubiquity of users' access to the Internet and/or communications airways, there is an ever-increasing demand for expanded services, functionality, online storage, sharing capabilities, and the like. One of the most visible and popular of these services is personal messaging using various techniques and such as SMS, OTT (Over-The-Top), MMS (Multimedia Messaging Service), texting, and the like. These technologies offer quick, reliable, effective, personal, and private communications to individuals and businesses at affordable costs.

To use such messaging services, users often use their contact lists or phonebooks, which include contact information such as phone and email, address, pictures, personal information, work/business information, family information, and many other types information associated with individuals. Also, users often have multiple contact lists, which although often overlap in content, but are not identical. A user may have one contact list on a first email account or other network account that includes friends A, B, and C, and another contact list on a second account that includes friends A, C, and D. If a user wants to communicate with the missing friend B from his second account, he may first have to add the friend to his contact list on the second account.

Social networks typically depend on interconnecting users according to affinity, relationships, context, and/or other criteria. Establishing this interconnection between users develops value for the members and as a result the entire network as a whole.

However, the currently available social networks as well as other communication networks, once authenticate a requesting user, may provide and expose too much private information about the friends of the requesting user, potentially compromising the privacy of the friends.

### Illustrative Operating Environment

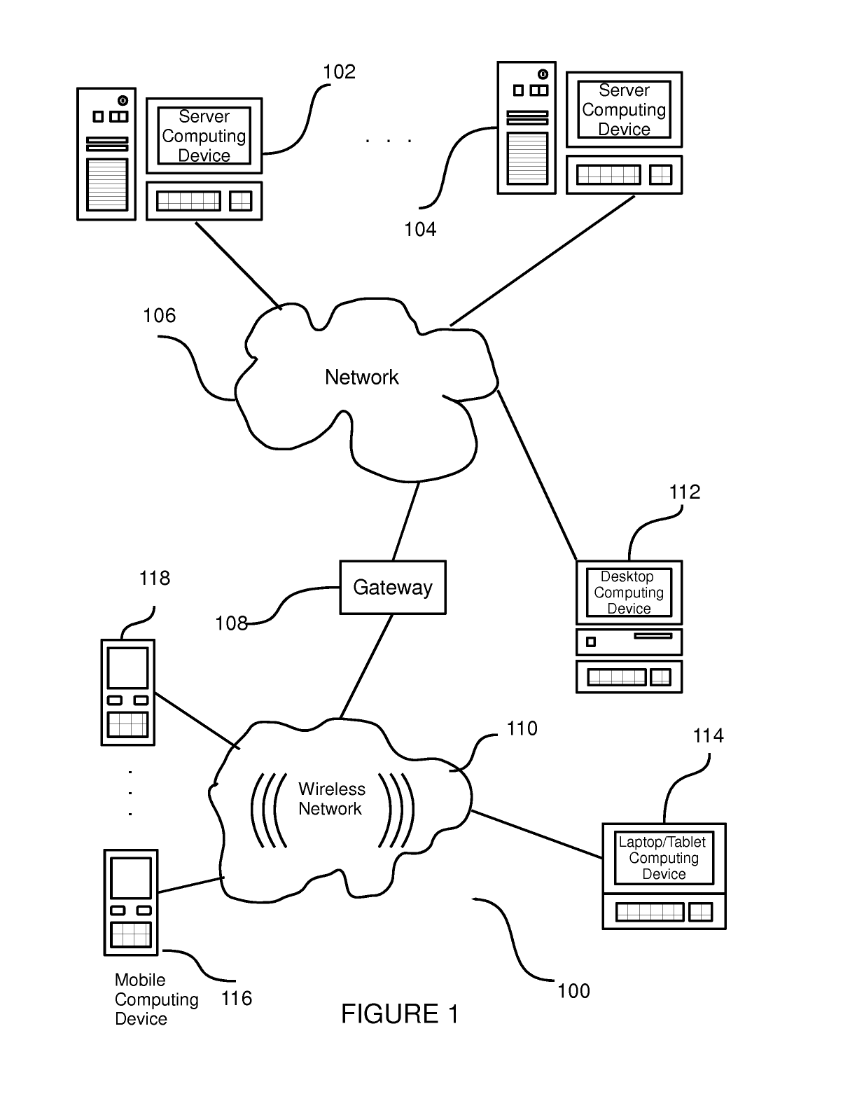

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

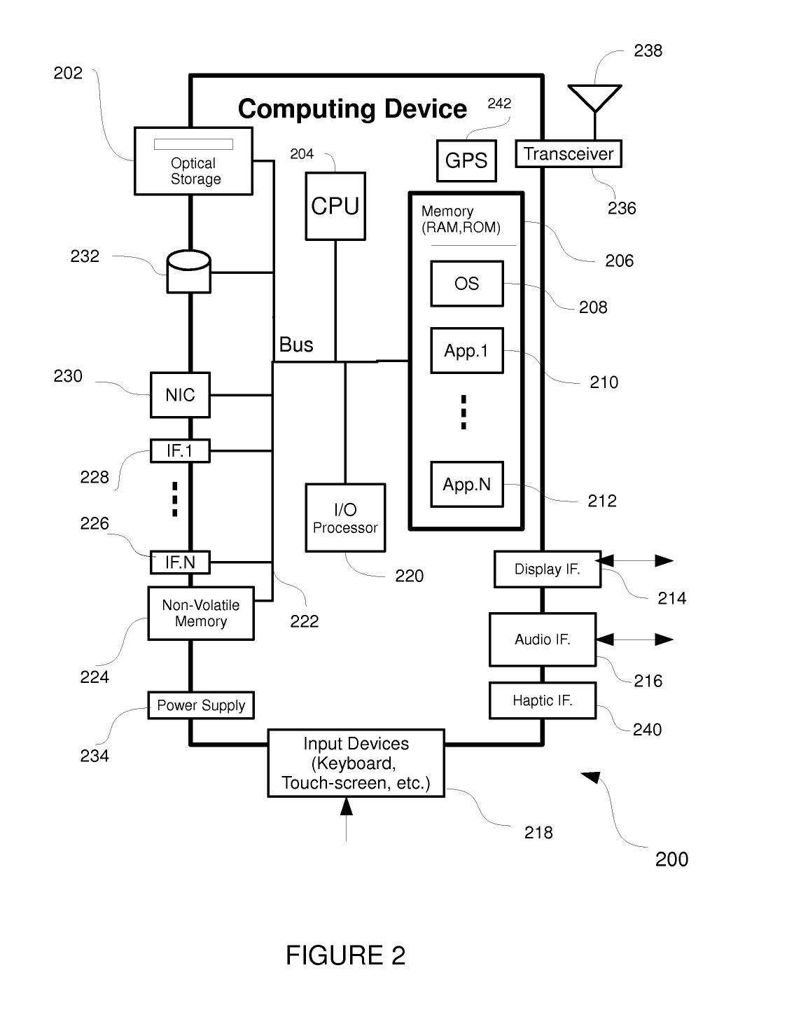

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), JavaScript Object Notation (JSON), or the like, to display and send information.

Client computing devices 112-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, Extensible Messaging and Presence Protocol (XMPP), or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ HDML, WML, WMLScript, JavaScript, SMGL, HTML, XML, JSON, and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

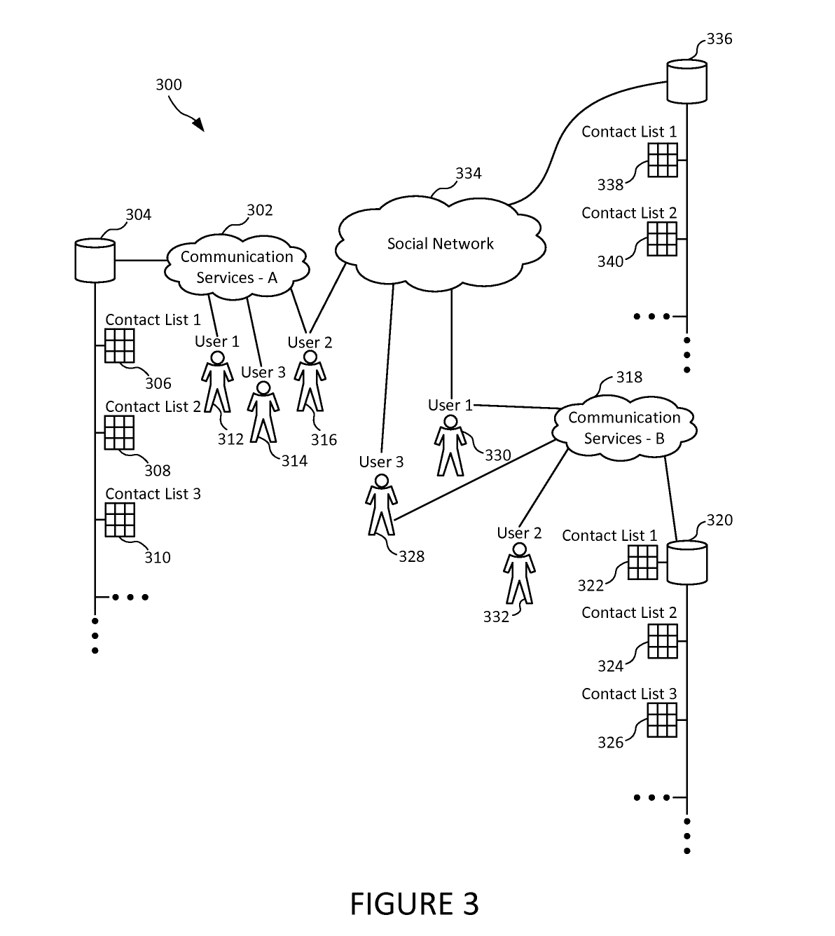

FIG. 3 shows an example user online interaction environment including social networks and other communication networks, each network with its own set of contact lists. In various embodiments, online environment 300 includes multiple communication services networks 302 and 318, with users 312-316 and 328-332 respectively, social networks 334 with users 316, 328 and 330. Communication services network 302 includes contact lists 306-310 for each of its corresponding users 312-316 stored on storage unit 304, and communication services network 318 has contact lists 322-326 for each of its corresponding users 322-326 stored on storage unit 320. Similarly, social network 334 has contact lists 338-340 for each of its users 316, 328 and 330 stored on storage unit 336.

In various embodiments, social network 334 may be similar to Facebook®, Google+®, Netlog®, etc. in which various users connect and communicate with their friends, family, business acquaintances, and the like. The other communication services 302 and 318 may be similar to Gmail®, Yahoo mail®, Outlook.com®, private corporate enterprise networks, government networks, and the like. Generally, each such communication or social networks may maintain one or more contact lists for each of their users so that the users can quickly identify and select the friends or coworkers they need to communicate with. The user's membership in a particular network generally entails having a private account on that network. Typically, the user logs onto his account on the network using personal credentials to authenticate his identity, such as a username and a password.

Those skilled in the art will appreciate that various networks, whether classified as social networks, communication networks, or otherwise, have many characteristics in common, such as contact lists, techniques and facilities for communications such as email and various types of messaging like SMS and text, and facilities for storing and retrieving messages like folders and conversation threads, among other similarities. Social networks differ from other types of networks mostly in their emphasis on particular types of content rather any absolute differences in the underlying technologies used. They also provide more facilities for support of such emphasized content. For example, a social network, such as Facebook, provides easier and more functional user interface for posting personal information such as pictures, personal profile, quick postings or opinions such as “Like” button (to signify a favorable evaluation of another post or page,) bulletin board style comments and group sharing, among other specialized and/or streamlined features, than a network primarily geared towards email communications such as Gmail.

One of the activity areas that social networks facilitate is the support of virtual or online groups of friends or associated people who know each other to different extents. As such, certain trust relationships may be established among members of these virtual groups that may be lacking in an email environment where many email solicitations or other non-personal communications may be received by users. Among these emails are commercial, advertising, professional, announcements, and other non-personal emails, many of the senders of which are not among the user's friends or in his contact list. Hence, in non-social network communication environments the trust relationship is often minimal compared with social networks.

A Friends Social Network (FSN), similar to network 334, may be used to connect users with people they already know for the purpose of private messaging and broadcasting. The FSN may use novel techniques and security best practices to establish connections between users on mobile devices. The FSN is particularly novel in the way in which it lets users add friends to the users' FSN contact list based on information in the users' existing phonebooks, find friends, and send messages to contacts in their address book without compromising personal information or degrading the ease of the user experience.

In various embodiments, the FSN includes servers, such as those discussed with respect to FIGS. 1 and 2, and software running on those servers or other computing devices, which implement the functions described herein. Such software may be similar to software modules 210-212 shown in FIG. 2. Those skilled in the art will recognize that the software may take many forms, such as standalone applications, web applications, DLLs, software plug-ins, and the like. Each function may be implemented by one or more such software modules. Each software module may also perform one or more of the functions provided by the FSN. For example, a contact list management module may include a number of other software modules, such as a contact list import software module, which may be used to find and import a contact list from another network. A contact list analysis software module may parse and mark entries in a contact list for further processing. Another contact list partition software module may take the marked contact list and partition it into two or more sections based on the software marks. Similarly, other software modules may be used to find users, authenticate user identities, and the like.

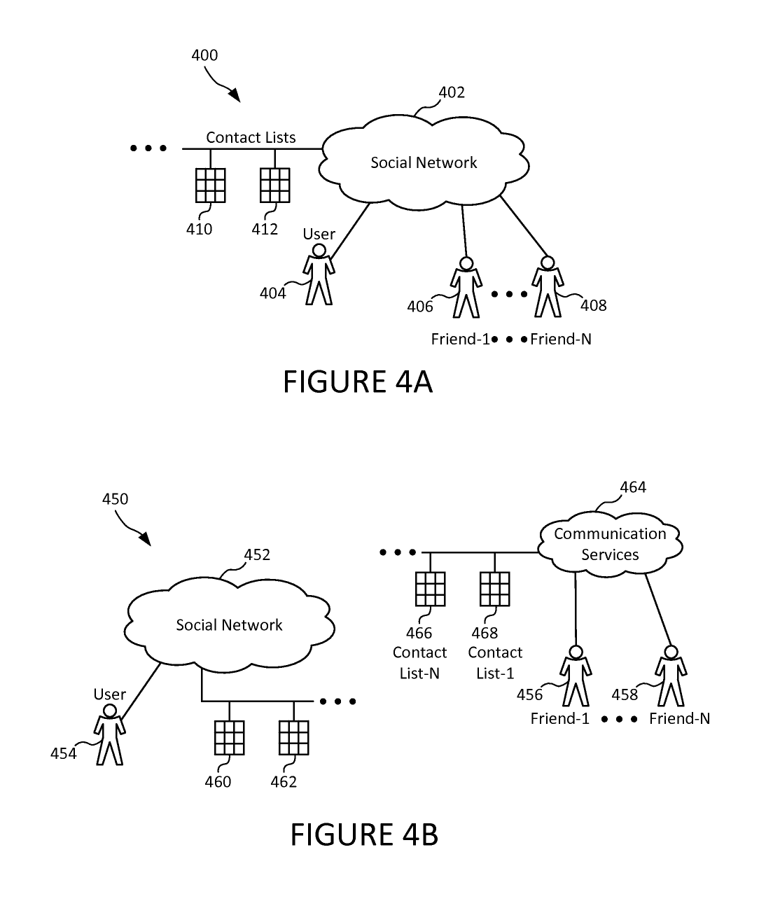

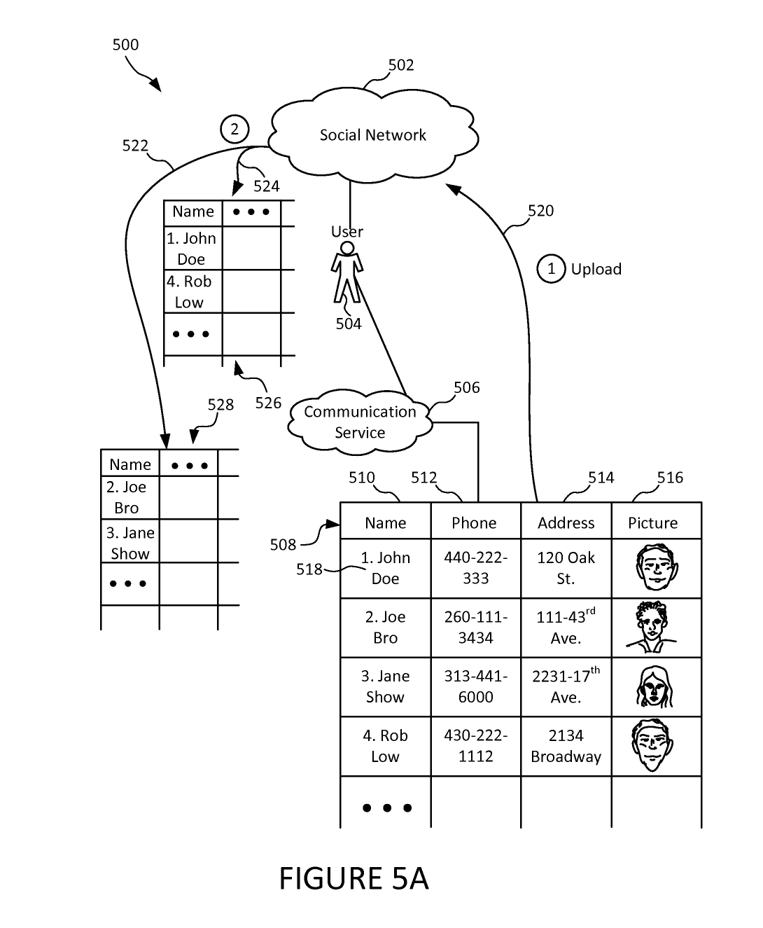

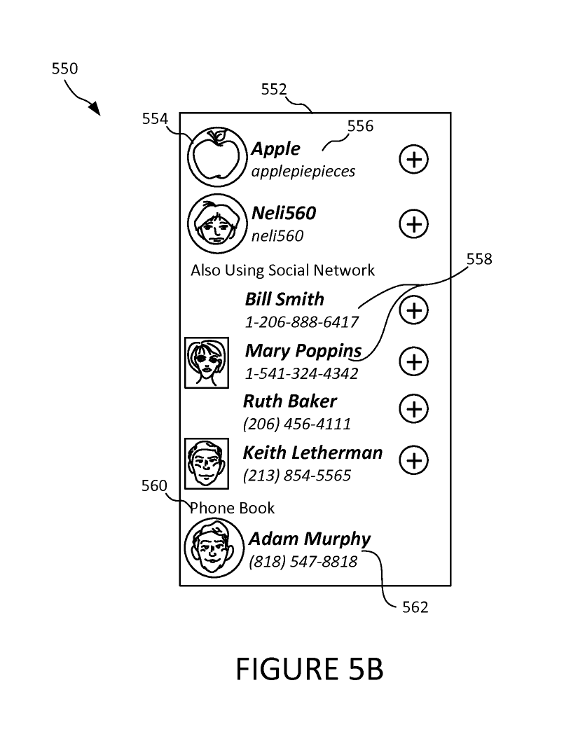

In various embodiments, the trust relationship embedded in a user's contact lists may be exploited to validate a user's relationship with the people on his contact list and/or to further extend trust levels among them without exposing information not already known by the user about his friends. With continued reference to FIG. 3, one or more users may be associated or be members of one or more networks, social or otherwise. The contact lists associated with a single user on multiple networks are often not identical, although they may have overlaps. For example, user 330 may be member of social network 334 with contact list 338 and also communication network 318 with contact list 322. The user 330 may have user 328 on his communication services contact list 322, but not his social network contact list 338. Hence, the user 330's contact list 322 may be used to establish a trust relationship between user 330 and user 328 on social network 334 without exposing more information about user 328 to user 330 than is already known to user 330. This is further described below with respect to FIGS. 4 and 5.

FIG. 4A shows an example social network with a user and friends, each being a member of the same social network as the user. In various embodiments, network environment 400 may include a user 404 as a member of social network 402. Other users who may be friends 406-408 of user 404 may also be members of the social network. Each user of the social network 402 may have one or more contact lists 410-412, which he uses to communicate or share information with his friends or acquaintances.

In various embodiments, a user may have more than one contact list on the same network. For example, he/she may have a contact list for close friends, one for family, one for professional associates, and the like. Each of these contact lists may be used to create new contacts on the present or another network based on the implied trust relationship between the user and his friends who appear in one or more of his contact lists, as further described below with respect to FIG. 5. In various embodiments, the contact lists associated with a user may built up within the network in which the contact list is used, or may be imported from another network by the user.

FIG. 4B shows an example social network with a user and friends, each being a member of a different network than the user. In various embodiments, network environment 450 may include a social network 452 having a user 454 and contact lists 460-462, a communication services network 464, with users who are friends 456-458 of user 454 and contact lists 466-468.

In various embodiments, one or more contact lists 460-462 may be associated with user 454. Similarly, one or more contact lists 466-468 may be associated with friends 456-458. Each of these contact lists may be used to create new contacts on the present or another network based on the implied trust relationship between the user and his friends who appear in one or more of his contact lists, as further described below with respect to FIG. 5. For example, the contact lists associated with user 454 may be used to validate his relationship with one or more of the friends 456-458 without exposing more information about the friends than user 454 already has in his contact lists.

FIG. 5A shows an example social network partitioning a user's contact list into two sections based on membership in the social network. In various embodiments, a network environment 500 may include a social network 502 having a member user 504 who is also a member of communication service 506. The user 504 may have a phonebook 508 associated with his account on communication service 506. The phonebooks may have multiple information fields associated with each contact entry 518 on the contact list, such as a name field 510, phone field 512, address field 514, and picture field 516, among others. The phonebook 508 may be uploaded to social network 502, as signified by arrow 520, and be partitioned into two sub contact lists 526 and 528, as signified by arrows 524 and 522, respectively.

In various embodiments, a friend finder software module/application of the FSN may allow an existing member-user to upload his/her contact list or phonebook to determine which people in his/her phonebook already have accounts with the FSN. However, instead of returning personal information for the people who have accounts, the FSN returns a partitioned contact list with two sub-lists including the same set of phone numbers or contact information that were originally uploaded from the user's phonebook. These phone numbers are partitioned into two sections: users who already have accounts with FSN, and those who do not. This provides the same benefit and value to the user, but without exposing personal information about the existing FSN users, such as public identifiers or their profile information stored within social network 502, thus protecting their privacy. So, even though no additional information about the existing users is returned to the requesting user, the friend finder software application is still able to show useful information by simply using the requesting user's existing phonebook data. Therefore, no personal information is exposed, but the requesting user still has a good user experience and can add new friends to his FSN contact list.

In various embodiments, the friend finder software application may upload the requesting user's phonebook, compare it row by row, with an internal FSN member list, and create a new partitioned phonebook with the two partitions mentioned above. Those skilled in the art will appreciate that the partitioning may be implemented by creating two separate sections in the phonebook, by marking the phonebook entries as being member or non-member, or by any other techniques that can easily make member and non-member entries of the phonebook distinguishable, without exposing additional information about those members or non-members.

In some embodiments, FSN members or users may also search for other FSN users by usernames. An exact match on a username may display the matched user's public profile (for example, first name and photo). FSN may also allow users the ability to turn off public profile visibility, in which case an exact username match may still return no results, and the only way to add friends to their FSN contact lists is by already knowing the friend's phone numbers (implying a more personal relationship), email address, or other unique identifiers.

FIG. 5B shows an example contact list details of a user of a social network. In various embodiments, contact list 550 of the user on the FSN includes listing 552 with entries partitioned into two or more groups. Entries 556 on top of listing 552 may include complete information about friends who have explicitly asked for or agreed to be added to a the user's contact list 550. Entries 558 belong to the partition that indicates the entries are in the user's phonebook, different from his contact list 550, and also have accounts on the FSN. Entries 562 in section 560 includes contacts of the user who are only his phonebook and not on the friends social network. Those skilled in the art will appreciate that the demarcated sections of listing 552 are merely one embodiment of the listing 552 allowing a clear user experience; for instance, all entries from sections 556, 558, and 562 may also be presented in a single section called “Friends,” where the source for those friends (FSN, phone book, etc.) may be less obvious.

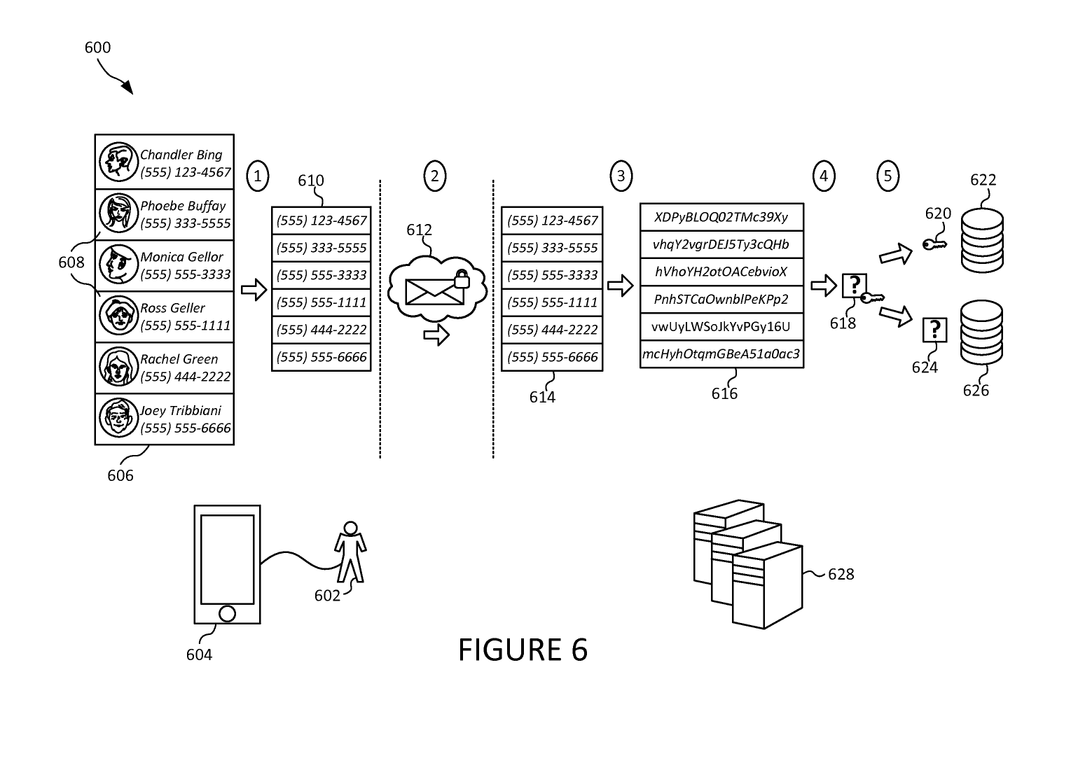

In various embodiments, to add friends to contact list 550 on FSN, a particular friend from the user's phonebook may be identified as either being already a registered (or otherwise associated) user of the FSN, or a friend who is not yet a member of the FSN. In the first scenario, a global identifier associated with FSN may be used to represent the particular friend in the user's contact list 550. The global identifier may be a combination of the friend's information that uniquely identifies the friend, such as a combination of his full name and birth date, or a GUID (Globally Unique ID). Throughout the social network discovery process, such as finding, adding, and sending messages to friends, global identifiers used to represent users may be sent from FSN's servers to various FSN client applications. These identifiers are global in the sense that a particular user would always be represented by the same identifier within FSN network applications. FSN's services may be designed such that these identifiers are never sufficient to provide personal information about any user, as further described below with respect to FIG. 6. They are simply used to act as placeholders for users who have not yet granted other users access to their personal information. Unlike other services and applications, this allows FSN to represent users without exposing personal information.

In some embodiments, FSN may not even expose these global identifiers. Instead, FSN may use per-user identifiers, such that every user receives a different identifier to represent every other user. For example, user A of FSN network may be represented by ID01 to user B and by ID02 to user C. This way, ID01 and ID02 both represent user A, but users B and C, who have received these IDs for user A, respectively, cannot identify user A based on these per-user IDs. These per-user identifiers would be mapped back to global identifiers only internally on FSN's servers. This way, another layer of privacy and security is provided for all users of FSN.

A “Friend Request” may be sent via the FSN servers to that particular friend, for example, as an email, a phone text, SMS, social network communication channels like walls or bulletin boards, or other similar communication methods. While the Friend Request is pending, the requesting user's phonebook information may be temporarily used for other information about that friend (e.g., name, photo, phone number, etc.). This information may be uploaded to FSN's servers and may be used permanently across all of the requesting user's devices, such as smartphones, tablets, laptops, and the like, but may only be accessed by the requesting user.

In the second scenario (friend not a member of FSN), FSN may pre-create an FSN global identifier for the particular friend, and then follow the same procedure as the first scenario. When the invited friend later signs up for FSN, the friend may then “claim” his pre-allocated global identifier.

When the invited friend later accepts the Friend Request, the requesting user's temporary profile information for the invited friend may be replaced by the friend's actual and more comprehensive profile information, that the friends may have provided to FSN upon enrollment. This way, the particular friend's privacy is protected until he accepts the Friend Request from the requesting user and a trust relationship is further established.

In various embodiments, FSN may also automatically accept Friend Requests on behalf of invited friends if FSN has data to support a trust relationship between the requesting user and the invited friend. For example, if the requesting user wants to add the invited friend to his friends list, FSN first checks to see if the requesting user is presently in the invited friend's phonebook. If so, FSN may assume that the requesting user and the invited friend know each other and have a trust relationship established. So, at this point, FSN may automatically add the invited friend to the contact list of the requesting user. Such automatic actions by FSN may be overridden or enhanced by privacy settings of the requesting user and/or the invited friend. For example, the invited friend may have a privacy setting that prohibits adding his name to anybody else's list unless the invited friend explicitly approves such addition. Other privacy settings may include various degrees of trust defined between the user defined by number of previous communications between them, duration of acquaintance between two users since their first communication, number of common or mutual acquaintances, and the like.

In various embodiments, when a new user joins FSN and uploads his phonebook, FSN may send in-app notifications (that is, notifications that are an integral part of the functions performed by an application) to the new user's friends who are already using FSN. This process may works as follows. First, FSN finds the people from the new user's phonebook who are already members of FSN. Then, for each of the people or members thus found, FSN checks their phonebooks to see if they contain an entry for the new user. Next, for each member of FSN with the new user in his or her phonebook, FSN may send an in-app notification letting them know that the new user is now using or a member of FSN. And finally, since FSN does not expose any personal information on other users, these notifications only use the profile information already available in the phonebook of the users/members to which the notifications are delivered. Thus, in order for these notifications to be delivered, both users must have each other in their phonebooks.

In various embodiments, the information included in the contact list 550 of the user is determined by the partition of the contact list to which the information belongs. For example, entries 556 are friends of the user who may have requested to be added to the user's contact list and who also agree, implicitly or explicitly, to expose their complete information to the user. Such information may include pictures and albums, birthday, address, cell phone, work information, personal profile, and other information associated with the friends. In various embodiments, the scope of the information exposed may be determined by a rating of the relationship between the user and the friend. Such rating may be based on trust level established between the user and the friend, type of relationship such as personal or business, a score assigned to the user by the friend such as a numerical or alphabetical score, and other qualitative and quantitative criteria. In some embodiments, these relationship ratings may be static while in other embodiments they may be dynamically updated up or down as the relationship evolves. The rating may also be based on one or a combination of factors discussed above.

In various embodiments, the friends 558 who are on both the user's contact list on the friends social network and on the user's phonebook, may only expose limited information to the user that is already in the user's phonebook, such as name and phone number. As discussed with respect to FIG. 5A, such limited information is obtained from the user's phonebook and no additional information is added.

In various embodiments, entries 562 on the user's phonebook 560 remain unchanged and are not added to the friend's social network.

In various embodiments, sending messages from one user to a friend works in a similar fashion to adding friends. If the sender has not yet added this friend to his friends list or contact list, then procedures are performed similar to those of adding a friend described above, and the message is sent to a quarantined inbox for that friend. More specifically, in the case that the friend is already a member of FSN, a “Friend Request” may be sent via the FSN servers to that particular friend, for example, as an email, a phone text, SMS, social network communication channels like walls or bulletin boards, or other similar communication methods. While the Friend Request is pending, the requesting user's phonebook information may be temporarily used for other information about that friend (e.g., name, photo, phone number, etc.). This information may be uploaded to FSN's servers and may be used permanently across all of the requesting user's devices, such as smartphones, tablets, laptops, and the like, but may only be accessed by the requesting user.

In the second scenario (friend not a member of FSN), FSN may pre-create an FSN global identifier for the particular friend, and then follow the same procedure as the first scenario. When the invited friend later signs up for FSN, the friend may then “claim” his pre-allocated global identifier. So, the friend will never see any of these messages until he accepts the sender's Friend Request. Meanwhile, the sender, but not others, may still see profile information for that friend, but that information originated from his own phonebook and the privacy of the friend is not compromised.

Since the global identifiers are pre-created for friends who have not yet joined FSN, these users can therefore have messages sent to them before even creating an account. Once they create accounts, their messages will be waiting for them in their inboxes.

Through these novel techniques, FSN may be able to provide a very simple, positive user experience for those trying to add friends or send messages, while never exposing the personal information of other users or friends.

FIG. 6 shows an example process of encryption and protection of a user's contacts. In various embodiments, encryption process 600 includes an initial contact list 606 having non-encrypted entries 608, which may be stripped to a subset of information they contain, such as phone numbers, and saved in a new limited list 610, which may be transmitted via a secure data packet 612 to the Friends Social Network (FSN) server facility with servers 628 and be recovered from the packet as limited list 614, containing the same information as limited list 610. Limited list 614 may then be encrypted, using various suitable techniques and algorithms, and saved in an encrypted list 616. In some embodiments, each entry may be cryptographically hashed using a hash function. The entire list may then be encrypted using a symmetric key encryption algorithm into an encrypted list 618. The symmetric key algorithm generates two encryption keys, which may be used for decrypting the encrypted list 618. The encryption keys 620 may be stored in database or storage 622, while encrypted list 618 may be stored in a separate database or storage 626 as list 624. User 602 may interact with FSN using a computing device 604.

A hash function is a mathematical function that maps input data (original data) of arbitrary size to output data (encrypted data) of fixed sizes (hash values). The importance of hash functions is that hashing is a simple way to make a small change in the input to become a large change in the output. So, even if a single letter or number is changed in a large data set, the resulting hash value the output will be totally different from the hash value of the unchanged data set. Another property of hash functions is that the hash function is one-way and the input cannot be easily reconstructed from the output. Hash functions generally do not produce unique mapping from input to output, so it is possible that some inputs may map to the same output, a condition known as collision. But a good hash function minimizes such collisions to near zero for practical purposes. Examples of hash functions are Secure Hash Algorithm 0 (SHA-0,) SHA-1, SHA-2, and SHA-3.

In various embodiments, the user's phonebook may be stripped of all personal information, aside from phone numbers. Then the phonebook is transmitted to FSN servers over an encrypted connection such as a Secure Socket Layer (SSL). By cryptographically hashing each phone number in the phonebook, all the phone numbers are obfuscated. The entire phonebook, may also be encrypted using a symmetric key algorithm, such as Twofish, Serpent, Advanced Encryption Standard (AES), Blowfish, CASTS, RC4, 3DES, and IDEA. These algorithms fall into one of two general types of algorithms, stream or block ciphers. Stream algorithms treat all data as one long and continuous stream, while block algorithms divide up the data into predetermined block sizes and encrypt each block separately. The encrypted phonebook may be stored in one database system, while encryption keys may be stored in a second database system. This way, even if one of the databases is exposed and its security is breached, without the information in the other database, the data still remains secure and cannot be deciphered.

In various embodiments, FSN may transmit personal information over an encrypted connection such as SSL or other secure communication channels. Once the information is transmitted to FSN's servers, the actual or original information in plaintext by which people may be identified need not be stored on the servers. Rather, such information are represented by their encrypted versions. It may generally be sufficient to use cryptographic hash functions to permanently obfuscate any unique user identifiers. For instance, the phone number (555) 555-5555 may become a5ad7e6d5225ad00c5f05ddb6bb3b1597a8. The mathematical properties of these functions, as briefly described above, may allow such identifiers to be used to uniquely represent the original numbers, without FSN ever storing the actual original numbers. Even if the obfuscated numbers are exposed, no user information (e.g. phone numbers) will actually be exposed. Among other uses, FSN may use this technique for storing uploaded phonebooks.

Once all values have been obfuscated, FSN may encrypt these values (for instance, using a symmetric-key algorithm) with an encryption key. FSN can then store the encryption key in one database and the encrypted values in a second database. FSN can ensure that these databases are in separate systems, such that exposing one database does not expose the other. If the key database is exposed, the data in the other database can be re-encrypted safely. If the values database is exposed, the data cannot be decrypted and read since the keys are not available.

It will be understood that each step in the described processes and techniques can be implemented by computer program instructions. These program instructions may be provided to a processor to produce a machine, such that the instructions, which execute on the processor, create means for implementing the actions specified in the process. The computer program instructions may be executed by a processor to cause a series of operational steps to be performed by the processor to produce a computer implemented process such that the instructions, which execute on the processor to provide steps for implementing the actions specified in the process. The computer program instructions may also cause at least some of the operational steps described to be performed in parallel. Moreover, some of the steps may also be performed across more than one processor, such as might arise in a multi-processor computer system. In addition, one or more steps or combinations of steps in the described processes may also be performed concurrently with other steps, or even in a different sequence than illustrated without departing from the scope or spirit of the disclosure.

It will also be understood that each step of the described processes or combinations thereof, can be implemented by special purpose hardware based systems, which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A contact management communication system comprising:
a contact management software module that when executed on a computing device causes the computing device to:
import a user's original phonebook;
find entries in the original phonebook, which are associated with members of a Friends Social Network (FSN); and
return a partitioned FSN contact list including two sub-lists, wherein a first sub-list includes entries that are associated with members of the FSN, and a second sub-list that includes entries not associated with members of the FSN.

2. The system of claim 1, wherein the computing device is a smartphone.

3. The system of claim 1, wherein the user's original phonebook is associated with a communication service.

4. The system of claim 1, wherein the contact management software module is configured to find, add, and send messages to members of the FSN.

5. The system of claim 1, wherein the contact management software module is configured to assign a unique ID to each member of the FSN.

6. The system of claim 5, wherein the unique ID does not expose information usable to identify a member associated with the unique ID.

7. The system of claim 1, wherein the contact management software module is configured to assign multiple different unique IDs to each member of the FSN, wherein each of the multiple different unique IDs is made available to a different member of the FSN for each of other members of the FSN.

8. The system of claim 1, wherein entries from the original phonebook are hashed using a hash function.

9. The system of claim 8, wherein the hashed entries are encrypted.

10. A method of adding contacts to a contact list in a Friends Social Network (FSN), the method comprising:
importing a user's original phonebook using a contact management software module;
finding entries in the original phonebook, which are associated with members of the FSN;
adding new entries to an FSN contact list of the user, wherein the new entries exist in the original phonebook and are associated with members of the FSN; and
returning a partitioned FSN contact list including two sub-lists, wherein a first sub-list includes entries that are associated with members of the FSN, and a second sub-list that includes entries not associated with members of the FSN.

11. The method of claim 10, further comprising sending a message to a friend of the user to the user's FSN contact list to authorize sharing additional information about the friend with the user.

12. The method of claim 10, further comprising pre-assigning a globally unique ID to a friend who is not a member of the FSN.

13. The method of claim 10, further comprising adding information about a friend to the user's FSN contact list based on a trust relationship between the user and the friend.

14. The method of claim 10, further comprising quarantining messages sent to a friend who is not yet on the user's FSN contact list and releasing the messages for receipt when the friend is added to the user's FSN contact list.

15. The method of claim 10, further comprising hashing and encrypting entries from the original phonebook.

16. A method of protecting privacy of information during updating a contact list in a Friends Social Network (FSN), the method comprising:
importing a user's original phonebook using a contact management software module;
finding entries in the original phonebook, which are associated with members of the FSN;
adding new entries to an FSN contact list of the user, wherein the new entries exist in the original phonebook and are associated with members of the FSN, and wherein the new entries include no additional information than provided by the original phonebook; and
returning a partitioned FSN contact list including two sub-lists, wherein a first sub-list includes entries that are associated with members of the FSN, and a second sub-list that includes entries not associated with members of the FSN.

17. The method of claim 16, further comprising hashing and encrypting entries from the original phonebook.

18. The method of claim 16, further comprising pre-assigning a globally unique ID to a friend who is not a member of the FSN.

19. The method of claim 16, further comprising sending a message to a friend of the user to the user's FSN contact list to authorize sharing additional information about the friend with the user.

20. The method of claim 16, further comprising adding information about a friend to the user's FSN contact list based on a trust relationship between the user and the friend.
